(19) United States
(12) Patent Application Publication
(10) Pub. No.: US 2005/0114285 A1
(43) Pub. Date: May 26, 2005

(54) Data replication system and method

(76) Inventor: Frank A Cincotta, Westboro, MA (US)

Correspondence Address: NIELDS & LEMACK, 176 EAST MAIN STREET, SUITE 7, WESTBORO, MA, 01581, US

(21) Appl. No.: 10/495,038

(22) PCT Filed: Nov. 7, 2002
(86) PCT No.: PCT/US02/35735

Related U.S. Application Data
(60) Provisional application No. 60/332,406, filed on Nov. 16, 2001.

(51) Int. Cl. G06F 7/00

(52) U.S. Cl. 707/1

(57) ABSTRACT

System and method for sub-second data replication. The present invention provides the ability to replicate database transactions made on one computer to one or more local or remote computers instantly, utilizing the database management system's transaction log for the replication. The present invention intercepts transactions being sent to a database's transaction log and interprets and copies the transactions to one or more replica servers, as well as to the original existing database transaction log. This enables real-time reporting without taxing the transaction system, real-time backup and immediate disaster recovery, by offloading said activities from the transaction server to a replica server that synchronized with the transaction server in real-time. The system comprises a central server and a set of source and destination agents that can reside all in a local system, or can be remotely connected such as through a TCP/IP networks The central server controls a series of loadable modules to perform specific functions in the system, and an agent that runs on every machine in the system that has a relational database management system running. The agent is either a source agent, gathering data from a source database server, or a destination (or target) agent, applying the data to the destination database, or both a source and destination agent.

### BACKGROUND OF THE INVENTION

Enterprises produce increasingly vast volumes of data and demand its broad availability that challenges products to deliver high reliability, disaster protection, and real-time access without degrading enterprise application performance. The ability to query the most up-to-date data with reporting and analysis tools is increasingly critical for companies as they strive to gain deeper and faster insight into their dynamic business.

Conventional reporting methods place a high server load on critical databases systems. As a result, creating reports from the transactional system is usually kept to a minimum. Although applications for reporting and analysis may target replica databases instead of directly taxing the application source database, traditional replication methods, which may have significant data lag between the source and target, are typically hours or even days out of synchronization with the content of the master database.

Conventional disaster recovery systems utilize a secondary site, in stand-by mode, that is refreshed on a batch or interval basis. If a disaster occurs, the secondary site must be taken out of stand-by mode and placed in active mode, and an integrity check is performed on the database prior to bringing the application environment back online. As a result there can be a significant time lag between disaster and recovery, as well as, significant data loss due to the batch or interval refresh of the secondary site causing a time lag between the primary site updates and the last secondary site update before the disaster.

For most database management systems, transactions are logged to transaction files in binary format after the database operation has been committed to the database.

It would be desirable to provide real-time data replication for relational databases, enabling multiple databases to hold current and consistent data regardless of their physical location.

It is therefore an object of the present invention to provide a system and method for real-time reporting without taxing transaction systems regardless of the number of queries.

It is a further object of the present invention to provide a system and method for real-time data backup without stopping or interrupting the one or more applications running.

It is still a further object of the present invention to provide a system and method for immediate disaster recovery.

### SUMMARY OF THE INVENTION

The problems of the prior art have been overcome by the present invention, which provides a system and method for sub-second data replication. The present invention provides the ability to replicate database transactions made on one computer to one or more local or remote computers instantly, utilizing the database management system's transaction log for the replication.

More specifically, in a conventional database application, the user's client application sends transactions to the database server. The database management system first commits the transaction to the database's storage medium then writes the transactions to its “transaction log”. The transaction log maintains a record of all activity associated with the database. In the event that the database fails, this log file can be used to reconstruct the contents of the database. The present invention interposes a simulated transaction log between the database management system and the database transaction log, thereby intercepting transactions being sent to a database's transaction log. It then interprets and copies the transactions to one or more replica servers, as well as to the original existing database transaction log. This enables real-time reporting without taxing the transaction system, real-time backup and immediate disaster recovery, by offloading said activities from the transaction server to a replica server that synchronized with the transaction server in real-time. The invention is particularly applicable to an enterprise comprising one or more physically separate operating environments, each operating environment having a database server interfacing with one or more application servers, each database server having a transaction log adapted to receive a transaction from the database server.

In accordance with a preferred embodiment of the present invention, the system comprises a central server and a set of source and destination agents that can reside all in a local system, or can be remotely connected such as through a TCP/IP network. The central server controls a series of loadable modules to perform specific functions in the system, and an agent that runs on every machine in the system that has a relational database management system running. The agent is either a source agent, gathering data from a source database server, or a destination (or target) agent, applying the data to the destination database, or both a source and destination agent.

### BRIEF DESCRIPTION OF THE DRAWINGS

FIG. 1 is a flow diagram of the system architecture in accordance with the present invention.

FIG. 2 is a flow diagram of the system architecture in a second embodiment of the present invention.

FIG. 3 is a flow diagram of the system architecture in a third embodiment of the present invention.

FIG. 4 is a flow diagram of the system architecture in a fourth embodiment of the present invention.

Appendix 1 is pseudo code describing the specific code modules in the present invention.

### DETAILED DESCRIPTION OF THE INVENTION

The replication system of the present invention comprises four primary components, namely, a device driver, a source agent, a destination or target agent and a central hub or server.

A device driver consists of a set of routines that control a system device (i.e. hard drive, mouse, monitor, keyboard). A device driver is installed on the source database server to simulate a regular disk file or raw device on the source system's operating system. The important operations that can be performed on it are read, write and seek. The original transaction log files pre-existing in the source database are moved to another directory for disaster recovery purposes. This allows the same transaction log file names to be linked to the created device. Accordingly, when a new or updated transaction is written out to the transaction log file, the device driver is able to “intercept” the transactions, and the transaction is instead written out to the device driver, since the device driver is now posing as the original transaction log file. Thus, when the database manager attempts to write any transaction step to the log file, it is instead written to the device driver, which then places it in an in-memory queue for the source agent to read. When the source agent reads from the in-memory queue populated by the device driver, it writes the binary information contained in the queue to the central hub, it at the same time also writes a copy to the original transaction log files residing in the newly designated directory. In case of disaster, these newly designated transaction log files can be used to restore the database to its latest status since they are always in synchronization with the target replicated database.

Referring to Appendix 1, page 1, lines 30-60, this pseudo-code initializes the device driver and allocates the memory needed for data buffers. Page 2 explains the various actions of the device driver. The Read_from_Driver routine, lines 1-28, is executed when the Source Agent queries the device driver for new transactions. The routine simply copies the data passed to it by the database application to user space. The Seek_on_Driver routine, lines 30-44 and the Write_to_Driver routine, lines 46-55 are executed when the dB application accesses what it believes to be the transaction log. The device driver emulates the behavior of the log file so that the database application continucs to function as designed.

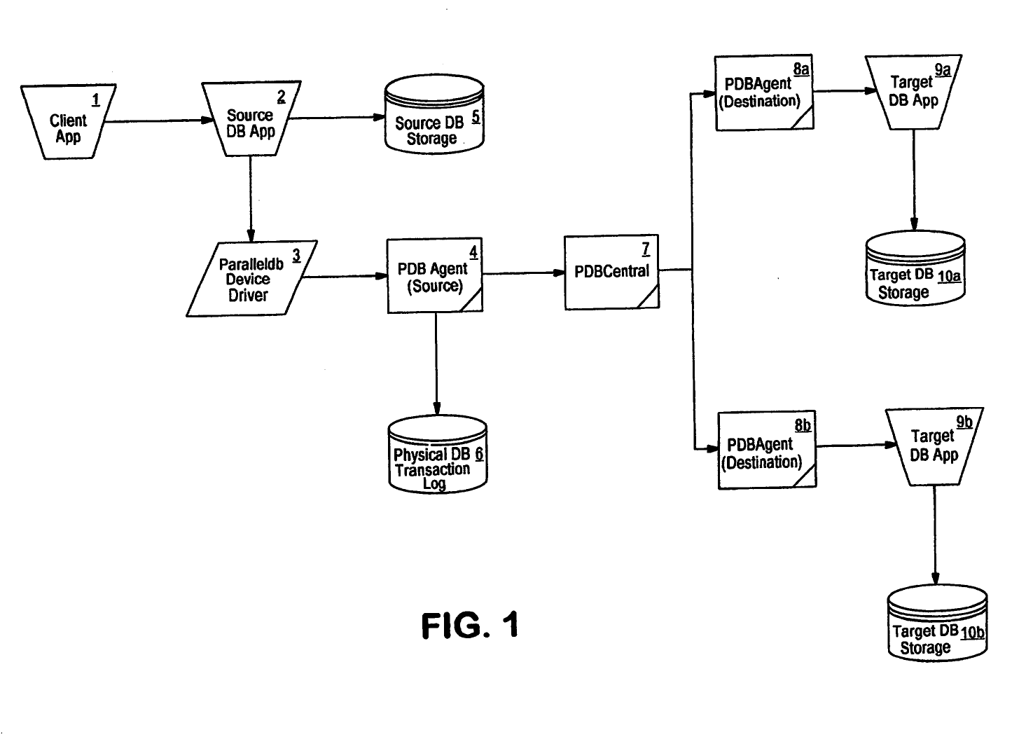

Turning now to FIG. 1, a source database 2 is in communication with source database storage 5, such as a disk or other storage medium, and a device driver 3. When a client application 1 (which application is not particularly limited, and by way of example can include human resource applications, customer relationship management and enterprise resource planning) writes to the source database, and, in turn, the source database writes to the source database 2 transaction log, the data is intercepted by the device driver 3 which queues the transaction. The driver 3 sends a signal to the source agent 4 to notify it that there is a transaction pending. In response, the source agent 4 fetches the transaction, and writes it to the physical transaction log 6. The source agent 4 also forwards the transaction to a Central Server 7, such as via a TCP/IP connection. The Central Server 7 preferably converts the incoming transaction data from the database transaction log proprietary format to a generic statement (e.g., ANSI SQL), and sends a copy of this transaction to one or more destination agents 8a, 8b identified as receiving a replica of this data. The one or more destination agents 8a, 8b apply the data to the destination database 9a, 9b, respectively (each having a respective database storage 10a, 10b), via native database methods appropriate for their database management system.

For example, for DB2, there are three transaction log files in the DB2 designated directory, namely, S0000000.LOG, S0000001 LOG and S0000002.LOG. The installer for this invention moves these files to a new directory and links them to the generated devices. Corresponding to the three log files, there are six devices, namely, /dev/paralleldb0 (master) and /dev/paralleldb1 (slave) for S0000000.LOG; /dev/paralleldb2 (master) and /dev/paralledb3 (slave) for S0000001 LOG; and /dev/paralleldb4 (master) and /dev/paralleldb5 (slave) for S0000002.LOG. The master devices are associated with their own section of memory buffers and they are the location where DB2 writes the transaction steps. In order to ensure that only it can manipulate the memory pointer in a memory buffer, the agent copies the memory buffer to another section of memory for each slave device. The agent read operation thus actually happens against the slave devices instead of the master devices.

The source agent and destination agent are also primary components of the present invention. The source agent resides on the transaction server whose database is to be replicated. The destination agent resides on the system that will replicate the database of the transaction server.

Initially during start-up of the system, the agents wait to be contacted by a central server, such as over a special TCP port. When a user creates a relationship on a central server that includes the server that the agent is residing in, as either a source or destination agent or both, the agent receives its configuration information including the identity of the central server, which database instance it will be using, and what its function will be (i.e., source, destination or both). The agent stores this data locally in a disk configuration database, so that the next time the agent is started, it will read from the disk configuration database and be able to start functioning immediately.

If the agent is acting as a source agent, it contacts the source database and (using native database calls) obtains information about the instance it will be replicating (e.g., table, column names, constraints, etc.). It then caches this information and forwards it, preferably via TCP, to the central server for use in the SQL translation process discussed in further detail below. The source agent then contacts the device driver to set a block, and waits to be notified of new data arriving in the driver.

Referring to Appendix 1, page 3, lines 20-32, the main thread of the agent continuously checks for requests from the replicator for information concerning connections or configuration information. Upon receiving such a request, it processes the request and returns the information to the replicator.

When the source agent is notified of the arrival of new data, it reads the transaction log file (in database transaction log proprietary format) and sends the transaction binary data to the central server. The source agent also is responsive to the central server, thereby enabling the central server to proceed with the database replication process as discussed in greater detail below. Each source agent is responsible for reading the transaction data from the device, via the device driver, so that it can be sent to the central server replicator. The source agent is also responsible for saving data to the original (pre-existing) transaction log files in the designated area. This is preferably carried out while the source agent is sending the transaction data to the replicator component of the central server. In the event of a disaster, the original transaction log files are always ready to be used to recover the database to its latest status without requiring an integrity check.

Referring to Appendix 1, pg. 3, lines 34-45 the source agent contains a Source thread and a Queue thread. The Source Thread continuously checks the device driver for new IO. When a new command has been received, it copies the data to the local transaction log and also places this new data in the outbound queue. The Queue Thread, p. 3, line 54 to p. 4, line 8, continuously checks the queue for new entries. Upon receipt, it sends the IO to the replicator, and waits for an acknowledgment from the replicator. When it receives the acknowledgment, the IO is removed from the queue. If the acknowledgement is not received, the entry will remain in the queue and will be retried later. This behavior is critical in order to guarantee delivery and therefore allow the invention to survive network outages and power outages.

Each target or destination agent is responsible for receiving the SQL commnands sent by the central hub or server, and applying them to the destination database. Specifically, each destination agent sets up a connection to the destination database, and awaits data, preferably via a TCP socket, from the central server. When data are received by the destination agent, the data have already been translated by the central server into a generic language (e.g., ANSI SQL format). The destination agent applies the data, using OCI or CLI, for example, to the destination database. The translation by the central server can be particularly important, since by converting to a generic language, the use of the system and method of the present invention is not limited by the databases involved. Those skilled in the art will appreciate, however, that where all databases involved recognize the same language (e.g., they are from the same manufacturer), the central server could be used in a pass through mode where translation to a generic language is not necessary.

Referring to Appendix 1, page 4 lines 10-17, the Destination Thread continuously polls for new SQL commands from the replicator. Upon receipt of a command, it applies it to the target database via a native database connection. Once the operation has been successfully performed, it returns an acknowledge to the replicator, signaling to the hub that this command can be removed from the queue.

The central hub is composed of three major components: the Management Console, the Controller and the Replicator.

The Management Console is for configuration. Preferably configuration is carried out via a web browser, and the Management Console is both an HTTP server and a Web-based graphical user interface (GUI) responsible for hosting the HTML management console and supporting customer actions directed from the console GUI. Through the Web GUI, users can define source/destination agents relationships and specify locations of the transaction log files and devices. The Management Console also provides a management interface to control the running processes of the Replicator, Controller and Management Console itself.

The Management Console provides two sets of operations, namely, the Server Tasks and the Database Relationships. The Server Tasks allow the user to turn on or off processes of the Replicator, Controller and the Management Console. The Database Relationships allow the user to add, modify or delete the source and target database relationships. Once a relationship is added to the system, it is stored in a local Indexed Sequential Access Memory (ISAM) database and then the appropriate agents are contacted (e.g., via TCP) to set up the replication. The source agents then sends information to the central server about the instance they are monitoring. This information is cached on the central server for use in the SQL translation process.

Referring to Appendix 1, page 4, lines 29-44, the main thread continuously polls for new console commands and acts upon them as required.

The Controller is responsible for communicating with the agents in the system, i.e., sending relationship changes to the source and destination agents, and acting on the user configuration changes sent from the Management Console and notifying the involved agents of the changes.

The Replicator is the hub for the entire database replication process. It is responsible for the caching of the database schema in a binary tree (B-tree), converting transaction steps from binary to ANSI SQL commands, sending the ANSI SQL commands to all destination agents, and handling replication against multiple database instances. The transaction binary log data are composed of a continuous stream of schema or catalog information, tables and records. Internal to the database management system, each table is represented by numbers, i.e., table 1, table 2, etc. Internally, the database management system also represents the fields in a record by numbers, i.e., field 1, field 2, etc. When the Replicator reads a table number or field number, it makes requests to the source agent and asks for the table name or the field name. The source agent queries the database management system to determine the name of the table or field represented by the number. Upon receiving the response from the source agent, the Replicator caches the table name or field name into a B-tree. The Replicator parses the incoming transaction binary log data, converts them to a string of SQL commands. The Replicator inspects the incoming log data, looking for transaction/operation terminators to determine what the complete transaction was. It then sends the resultant SQL commands to one or more destination agent, such as via TCP sockets, that are identified as a target of that instance in a relationship.

Referring to Appendix 1, page 5, lines 12-39, the Source Agent Thread gets incoming log information from the source agent. Then, after receiving a terminator, converts the binary log information into SQL commands, and then queues these commands for each destination. Once this is completed, an acknowledgment is sent to the Source Agent, allowing it to remove this item from its queue.

The Destination Agent Thread, p. 4, line 53 to p. 5, line 10, monitors the queue for new SQL commands, and sends these commands to the destination. Once an acknowledgment is received from the destination, the item is removed from the queue. This is done to guarantee successful delivery even in the presence of network outages. There can be multiple instantiations of this thread to allow multiple destination replicas of the source database.

The user may choose to encrypt the resultant SQL commands before sending them to the destination agents to maintain the secrecy of the data. For example, if the destination agent is located on a server accessed via TCP/IP across the Internet, encryption can be used to insure the confidentiality of the information. At the user's discretion the SQL commands can also be compressed to minimize network traffic originating from the central hub.

The system is able to handle multiple threads of source/destination relationships because the Replicator maintains a linked list of converted SQL commands for each relationship thread. The SQL commands in the linked list are consumed by sending them out to the destination agent.

Underlying all of the components of the system of the present invention is an operating system translation layer, which implements both operating system primitives (semaphores, spinlocks, queues, etc.) and base level functions such as networking primitives (socket support, pipes, etc.). This layer also helps implement a key feature of the architecture, guaranteed network transport delivery. That is, all of the components in the system simply carry out a TCP send to pass data between components. The translation networking layer then queues that data (including a physical on-disk backup) and continues to forward the data to its destination until a confirmation is received. This guaranteed delivery will survive network outages, power outages and most system failures.

Another important feature of this invention is its ability to continue to operate and assist in disaster recovery. Referring to FIG. 1, source database 2 is the primary system, while databases 9a and 9b are replicas of this database. In the case of a disaster, database 2 becomes unusable. Once this condition is encountered, a replica of the primary database becomes the primary machine. Those skilled in the art will understand the mechanisms used to facilitate this. At this point, database 9a, which was a destination, now becomes the primary database. The Central Server 7, simply informs that machine that its agent 8a is now to operate as the source agent. Since the specialized code is resident in every agent, the agent simply changes from a destination to a source. It then operates in exactly the same fashion as the original source, sending its log information back to the central replicator, where it is processed and passed to destination agent 8b. In this manner, database 9b is still a complete replica of the primary database and is kept updated in real time.

The recovery process is still possible even when there is only one destination database. In that case, when primary database 2 fails, the operator must intervene to bring a new backup machine online. Those skilled in the art can appreciate that there are a number of ways in which to copy the contents of database 9a onto the new backup machine. Once that is completed, the destination agent 8a is reconfigured to be a source agent, and the agent in the new backup machine is the destination agent. As above, the central replicator relays SQL commands to the destination agent.

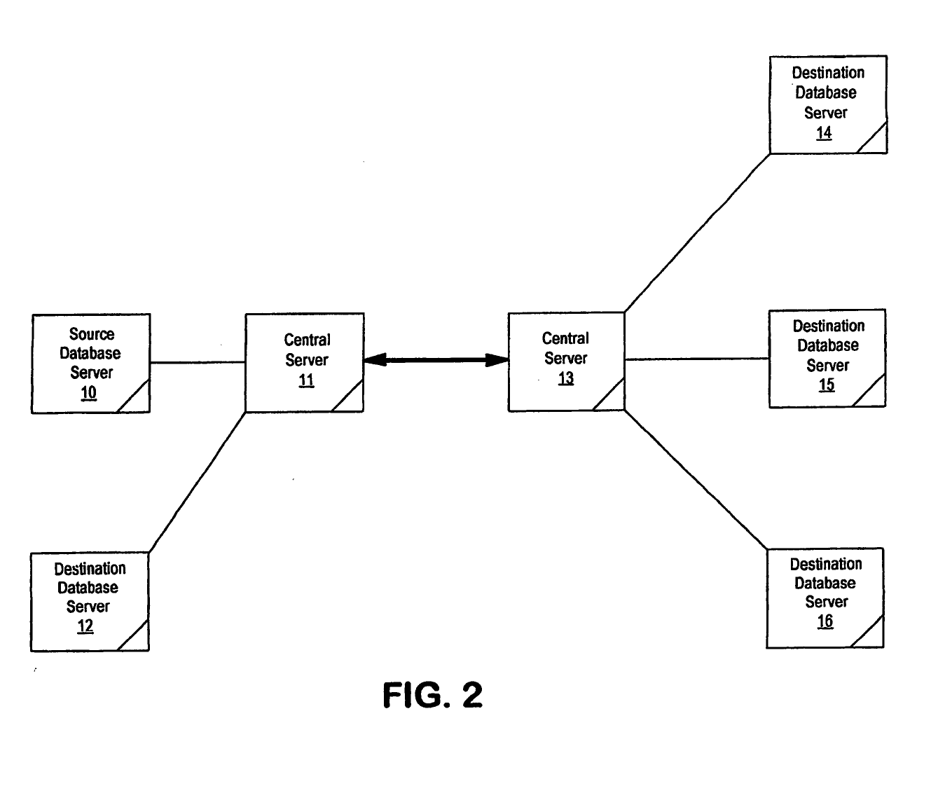

In a second embodiment, shown in FIG. 2, a second central server is employed. This topology is useful when the source and destination databases are geographically distributed. FIG. 2 shows the source database 10 connected to the first central server 11. This central server is located relatively close to the source database, and can also connected to one or more destination database servers 12. A second central server 13 is located a significant distance away, such as across the Atlantic Ocean, from the first central server 11. Destination databases 14, 15 and 16 are located near to the second central server 13. As transactions are being logged in the source database 10, it sends the information to the first central server 11. This central server then converts this information into SQL commands and distributes these commands to two servers, destination database server 12 and second central server 13. Central server 13 receives these SQL commands and queues them for destination databases 14, 15 and 16. In this way, the trans-Atlantic traffic is minimized, as communications are occurring only between central server 11 and central server 13. This example results in a 67% reduction in trans-Atlantic network traffic, as transactions are only sent to central server 13, and not to destination databases 14,15 and 16.

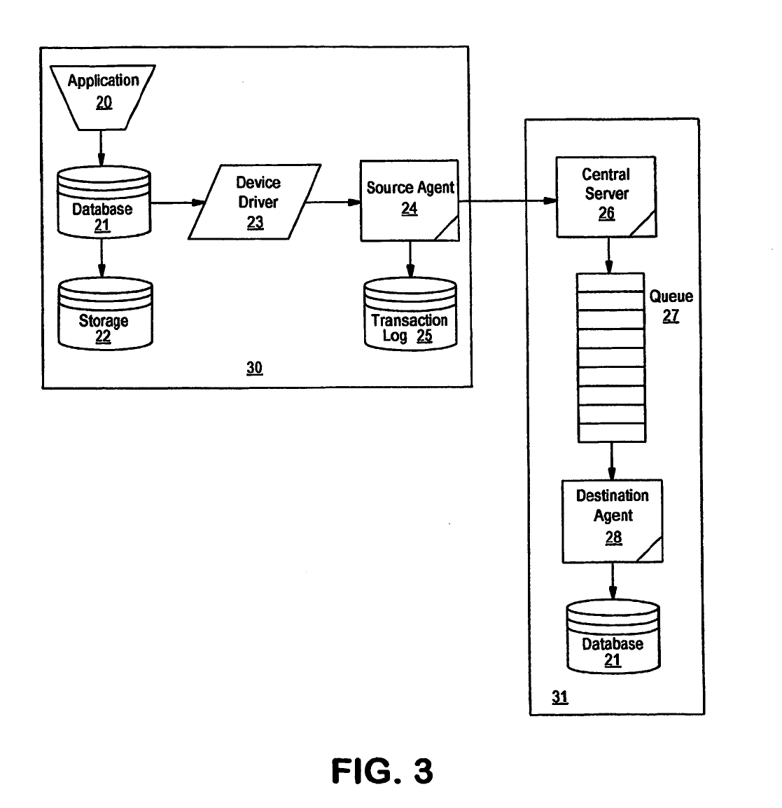

It is also possible to combine various elements of this invention in an attempt to minimize system components. FIG. 3 shows an embodiment wherein the functionality of the central server is combined with the server containing the destination database in a 1:1 data replication scenario. In this environment, server 30 contains the source related elements. The application 20 writes to the database 21 and to its local storage 22. As before, the data destined for the transaction log is intercepted by the device driver 23. The device driver then alerts the source agent 24. Source agent 24 sends the binary log information to central server 26, and copies it to the new transaction log 25. In this instance, the code associated with the central server is resident on the destination server 31. The central server 26 converts the binary data into SQL commands and then places them in a queue 27 for the destination agent 28, which is resident on the same server 31. The destination agent 28 then receives the item from the queue 27 and applies it to the destination database 29, which is also attached to the server 31. In this way, the source server 30 remains relatively unaffected by the replication since most of the central server processing is offloaded to the destination server.

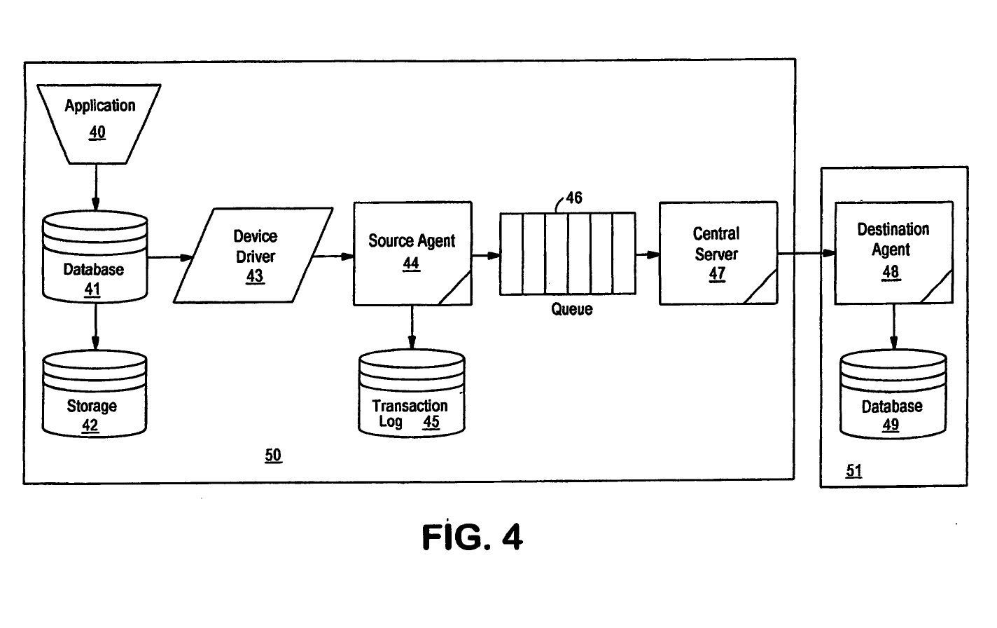

FIG. 4 shows another embodiment that combines some of the elements onto a single server. In this instance, the central server functions have been combined with the source database server 50. All destination actions reside on destination server 51. As before, the application 40 writes to database 41 and to its local storage 42. The data destined for the transaction log file is intercepted by the device driver 43. The device driver 43 then alerts the source agent 44. The source agent writes the information to the transaction log 45, and places it on a queue 46 to be processed by the central server code 47, which is resident on the source database server 50. The central server code 47 processes the binary data, converts it to SQL commands and sends them to the destination agent 48, which resides on the destination database server 51. The destination agent 48 applies these commands to the destination database 49. This embodiment reduces the amount of network traffic generated, as all of the processing and translation to SQL commands is done of the source database server 50.

[symbol]

pseudo code

```
The pseudo code in broken down into three main modules:
    1. The device drive module:
        The device driver interposes between the database and the transaction/redo
        log. This device driver manages all of the input/output from the database to
        the agent queues.
    2. The agent module:
        The agent module on the source machine receives binary data from the
        device driver, queues and cachcs time data, and sends the data to pdbCentral
        for processing.
        The agent module on the destination machine establishes a native database
        connection with the database engine on the destination machine. It then
        receives Structured Query Language (SQL) commands from pdbCentral and
        applies those changes to the database on the destination machine via the
        native database connection.
    3. The replicator module (on pdbCentral, which is the hub in the hub and spoke
        architecture):
        The replicator module resides on pdbCentral. This module manages the
        connection between the source database server and the destination database
        server(s). The replicator also manages the translation of data from binary
        form the Structure Query Language.
Device Driver Pseudo code
Initialize_Driver
{
Allocate the device contexts (per device)
Initialize the device contexts (per device)
Register driver with system
Initialize the command queue (per device)
}
Open_Driver
{
Grab the semaphore
Update the reference count
If (first time in)
  If master device
  Allocate memory for data buffers
  Initialize the data buffers
  else if slave device
  Assign the context pointers
Save the context pointer in the file pointer passed in
Release the semaphore
}
Read_from_Driver
{
Grab the semaphore
If this is the master device
  Add a read command to the slave queue
  Copy the data from the buffer to user space
else if the is the slave device
  Read the next command from the slave queue
  Switch on the command
  Case READ
    Remove the command from the queue
    Copy the read command to User Space
  Case SEEK
    Remove the command from the queue
    Copy the seek command to User Space
  Case WRITE
    Remove the command from the queue
    Copy the write command to User Space
  Case WRITE_DATA
    Remove the command from the queue
    Copy the data for the write to User Space
Release the semaphore
}
Seek_on_Driver
{
Grab the semaphore
Add a seek command to the queue
Switch on Seek_Ptr
  Case SEEK_END
  Set context position to end of buffer
  Case Seek_Set
  Set context position to seek position
  Or Else
  Add Seek position to context position
Release the semaphore
}
Write_to_Driver
{
Grab the semaphore
Copy the data from User space to kernel space
Add a write command to the slave queue
Add the data to the slave queue
Release the semaphore
}
Close_Driver
{
Grab the semaphore
Decrease the reference count
If last one out
  Deallocate buffers
  Unregister the device from system
  Deallocate the context blocks
Release the semaphore
}
Agent Pseudo code
Main Thread
{
Read configure database to get all source commitments
For each commitment, connect to the replicator
Loop forever:
  Check for connections from the replicator
  Process replicator/controller requests
    Table info lookup
    Column info lookup
    Change configuration in database (add/remove commitments)
    Create a destination thread
}
Source Thread
{
  Open Master/Slave device
    Write transaction log cache to the master device
    Start a queue thread to read the outbound data stream
    Loop forever
        Check the slave device for IO
            Read slave device
            Write data to local transaction log cache
            Place the IO in an out bound queue (to the replicator)
}
Queue Thread
{
    Loop forever
        Check the queue for new IO
            Send IO to the replicator
            Wait for a predefined time interval for an ack from the replicator
            If an ack is received from replicator
            {
                Remove the IO from the queue
            }
            else
            {
                Resend IO to the replicator
            }
}
Destination Thread
{
    Connect the database instance
    Loop forever
        Read SQL from replicator
        Apply SQL to target DB instance
        Send ack to replicator
}
Replicator (pdbCentral) Pseudo code
Main Thread
{
Loop forever
    Check for console commands from (console, controller and mconsole)
        When a new command arrives service the command (connect/disconnect to
        destination agent)
            connect - create a destination agent thread to connect & service the
            destination (from controller)
            disconnect - cause the destination agent thread to disconnect & exit (from
            controller)
            console command - service the command
    Check for a connection from a source agent
        When a new connection arrives launch a source agent thread to service the agent
}
Destination Agent Thread
{
    Connect to the target agent
    Create/Find the queue for the target instance
    Loop forever
        Check SQL command queue for a command
        Send SQL command to the destination agent
        Wait for a predefined time interval for an ack from the destination agent
        {
            Remove the SQL command from the queue
        }
        else
        {
            Resend SQL Command to the destination agent
        }
}
Source Agent Thread
{
    Get source agent info (Instance, Remote host name)
    Initialize the database schema BTree
    while connection to agent is up
    Does agent have data?
        Read data from the agent
        If data contains an transaction/operation terminator
        {
            if this is the first and only block of data for this transaction/operation
            {
                Convert binary log information into SQL
                Queue the SQL to all destination agents
            }
            else
            {
                Append data to previously received data buffer
                Convert data buffer into SQL
                Queue the SQL to all destination agents
            }
        }
        else
        {
            Append data to previously received data buffer
            Wait for next block of data
        }
        Send acknowledgement back to source agent
}
```

1. A method for data replication, comprising:
providing at least first and second database servers, each said server interfacing with at least one application server, said first database server having a source transaction log adapted to receive a transaction from a database management system, said second database server adapted to receive a transaction;
providing a computer program to simulate said source transaction log;
monitoring said database management system for receipt of a transaction;
intercepting said transaction prior to it reaching said source transaction log;
sending said intercepted transaction to said source transaction log;
sending a transaction selected from the group consisting of said intercepted transaction and a modification of said intercepted transaction to one or more said second database servers.

2. The method of claim 1, wherein said modification of intercepted transaction is a translation to a generic SQL statement.

3. The method of claim 1, wherein said at least one application server interfaces with at least one user.

4. The method of claim 1, wherein said second database server remains continuously available for modification by an application server.

5. The method of claim 1, wherein said intercepted transaction or said modified intercepted transaction is encrypted prior to being sent to said second database server.

6. The method of claim 1, wherein said intercepted transaction or said modified intercepted transaction is compressed prior to being sent to said second database server.

7. The method of claim 1, wherein said computer program is a device driver.

8. The method of claim 1, further comprising a central server for receiving said intercepted transaction or said modified intercepted transaction.

9. The method of claim 8, wherein said central server sends said intercepted transaction or modification of said intercepted transaction to one or more database servers.

10. The method of claim 8, further comprising directing said intercepted transaction or said modified transaction from said central server to a second central server, said second central server further directing said intercepted transaction or said modified transaction to one or more target transaction databases.

11. The method of claim 8, wherein said central server comprises said second database server.

12. The method of claim 8, wherein said central server comprises said first database server.

13. The method of claim 8, wherein said central server configures said first database server to act as source and said second database servers to act as a destination.

14. The method of claim 13, wherein said central server reconfigures said second database server to act as source when said first database server fails.

15. A data replication system, comprising:
an enterprise comprising one or more physically separate operating environments, each operating environment having a database server interfacing with one or more application servers such that said enterprise comprises at least one source database server and at least one destination data base server, each database server having a transaction log adapted to receive a transaction from a database management system, wherein at least one of said database management systems implements a source database and at least one of said database management systems implements a destination database;
a source program associated with said enterprise for intercepting a transaction prior to said transaction reaching said transaction log of at least one of said source database servers; and
a replication program interfacing with said source program for receiving said intercepted transaction and transmitting a transaction selected from the group consisting of said intercepted transaction and a modification to said intercepted transaction to one or more of said destination database servers.

16. The system of claim 15, wherein said replication program translates said transaction to a generic SQL statement prior to transmitting said transaction to said one or more destination databases.

17. The system of claim 15, wherein said replication program encrypts said intercepted transaction or said modified intercepted transaction.

18. The system of claim 15, wherein said replication program compresses said intercepted transaction or said modified intercepted transaction.

19. The system of claim 15, wherein said replication program transmits said intercepted transaction or said modified intercepted transaction to a plurality of destination databases.

20. The system of claim 15, wherein said replication program resides on a central server.

21. The system of claim 20, further comprising a second central server for receiving said intercepted transaction or said modified intercepted transaction from said central server and transmitting the same to a plurality of destination databases.

22. The system of claim 15, wherein said replication program resides on said destination database server.

23. The system of claim 15, wherein said replication program resides on said source database server.

24. The system of claim 15, wherein said replication program reconfigures one of said destination database servers to act as source database server when said source database server fails.

25. A method of capturing database transactions in real time, comprising:
providing a database server having a database transaction log and a resident database management system for receiving a transaction and forwarding said transaction to said database transaction log;
interposing a simulated transaction log between said database management system and said database transaction log; and
intercepting in said simulated transaction log any transaction forwarded by said database management system.

26. The method of claim 25, further comprising sending said intercepted transaction to said transaction log and to a replication program.

27. A system of capturing database transactions in real time comprising:
a database server having a database transaction log for receiving a transaction; and
a simulated transaction log for intercepting said transaction transmitted to said database transaction log.

28. The system of claim 26, further comprising a computer program for transmitting said intercepted transaction to said transaction log and to a replication program.
